(19) United States
(12) Patent Application Publication
(10) Pub. No.: US 2012/0240218 A1
(43) Pub. Date: Sep. 20, 2012

(54) METHODS, APPARATUSES, AND COMPUTER PROGRAM PRODUCTS FOR RESUMING A SUSPENDED SESSION

(75) Inventor: William Joseph Jansto, Cranberry Twp, PA (US)

(73) Assignee: McKesson Automation Inc.

(21) Appl. No.: 13/049,065

(22) Filed: Mar. 16, 2011

(51) Int. Cl. G06F 9/00; H04L 9/32; G06F 15/16

(52) U.S. Cl. 726/16; 713/1; 709/224

(57) ABSTRACT

Methods, apparatuses, and computer program products are provided for resuming a suspended session. A method may include determining a presence of a user within a predefined proximity of a workstation. The method may further include, responsive to determining the presence of the user, causing pre-retrieval of stored session state information for a suspended session associated with the user before the user enters credential information for logging onto the workstation. Corresponding apparatuses and computer program products are also provided.

### TECHNOLOGICAL FIELD

Embodiments of the present invention relate generally to computing technology and, more particularly, relate to methods, apparatuses, and computer program products for resuming a suspended session.

### BACKGROUND

In the modern computing age, multiple workstations are often connected by a network to a central server or data storage, which may provide access to data, an application, and/or the like. Accordingly, a user may access data from the server in any location having a workstation connected to the server. In some systems, a user may log onto a workstation and retrieve user-specific session data. In this regard, a user may be allowed to access and continue a session on a second workstation, which was begun on a first workstation. However, the user may be required to navigate several screens after logging onto the second workstation in order to retrieve data associated with the session and resume the session. Further, the user may encounter a delay due to a retrieval time that may be required for retrieving session data from the server after the user has logged into the second workstation and requested to resume the session.

### BRIEF SUMMARY OF SOME EXAMPLES OF THE INVENTION

Methods, apparatuses, and computer program products are herein provided for resuming a suspended session. These methods, apparatuses, and computer program products may provide several advantages to workstation users, workstations, servers, system administrators, and computing systems implementing various example embodiments. In this regard, some example embodiments provide for automatic detection of a user within proximity of a workstation and pre-retrieval of session data for a suspended session associated with the user in response to detection of the user within proximity of the workstation. Accordingly, the user may resume a session upon providing an access credential to the workstation without having to navigate through multiple screens or other procedures in order to request to retrieve session data for and resume a session. Further, since the user's session data may be pre-retrieved, the user may not have to wait for the data to be retrieved after logging on. In addition to enhancing the user experience, such example embodiments may improve workflow by reducing login and system wait time in time-sensitive environments, such as in hospital pharmacies wherein users may migrate through a series of dedicated workstations in order to fulfill orders.

In a first example embodiment, a method for resuming a suspended session is provided. The method of this example embodiment comprises determining a presence of a user within a predefined proximity of a workstation. The method of this example embodiment further comprises, responsive to determining the presence of the user, causing pre-retrieval of stored session state information for a suspended session associated with the user before the user enters credential information for logging onto the workstation.

In another example embodiment, an apparatus for resuming a suspended session is provided. The apparatus of this embodiment comprises at least one processor. The at least one processor is configured to cause the apparatus of this embodiment to determine a presence of a user within a predefined proximity of a workstation. The at least one processor is further configured to cause the apparatus of this example embodiment, in response to determining the presence of the user, to cause pre-retrieval of stored session state information for a suspended session associated with the user before the user enters credential information for logging onto the workstation.

In another example embodiment, a computer program product for resuming a suspended session is provided. The computer program product of this embodiment includes at least one non-transitory computer-readable storage medium having computer-readable program instructions stored therein. The program instructions of this example embodiment comprise program instructions configured to determine a presence of a user within a predefined proximity of a workstation. The program instructions of this example embodiment further comprise program instructions configured, responsive to determining the presence of the user, to cause pre-retrieval of stored session state information for a suspended session associated with the user before the user enters credential information for logging onto the workstation.

In another example embodiment, an apparatus for resuming a suspended session is provided. The apparatus of this example embodiment comprises means for determining a presence of a user within a predefined proximity of a workstation. The apparatus of this example embodiment further comprises means for, responsive to determining the presence of the user, causing pre-retrieval of stored session state information for a suspended session associated with the user before the user enters credential information for logging onto the workstation.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for resuming a suspended session according to an example embodiment;

FIG. 2 illustrates a block diagram of a workstation for resuming a suspended session according to an example embodiment;

FIG. 3 illustrates a block diagram of a session data source for facilitating resumption of a suspended session according to an example embodiment;

FIG. 4 illustrates a block diagram of a user device for facilitating resumption of a suspended session according to an example embodiment;

FIG. 5 illustrates an example multi-station workflow according to an example embodiment;

FIG. 6 illustrates a flowchart according to an example method for resuming a suspended session according to an example embodiment;

FIG. 7 illustrates a flowchart according to an example method for facilitating retrieval of session state information for a suspended session according to an example embodiment; and

FIG. 8 illustrates a flowchart according to an example method for triggering pre-retrieval of session state information for resuming a suspended session according to an example embodiment.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, and/or the like.

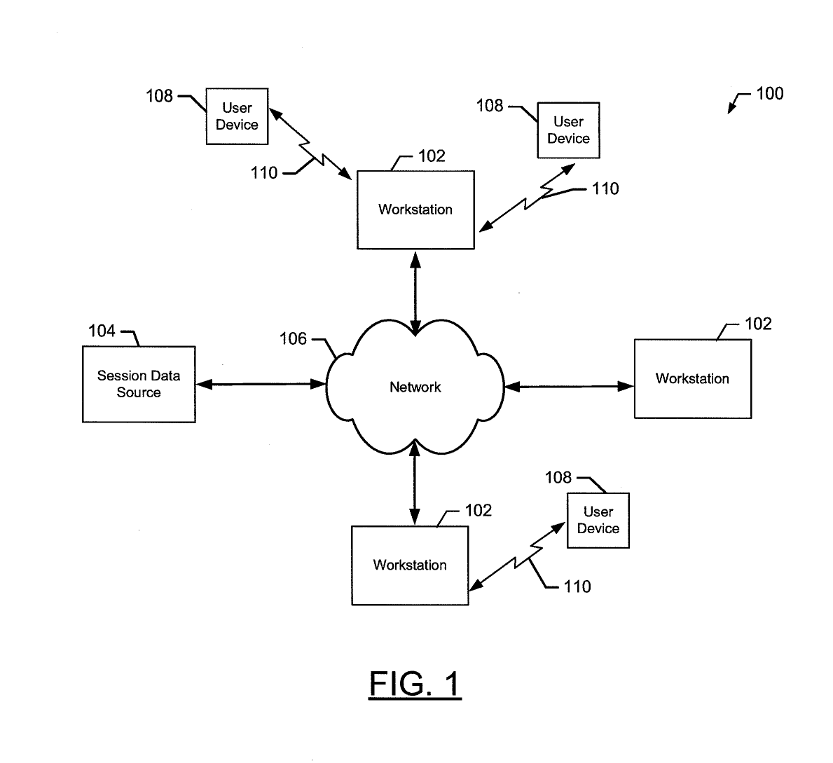

FIG. 1 illustrates a block diagram of a system 100 for resuming a suspended session according to some example embodiments. It will be appreciated that the system 100 as well as the illustrations in other figures are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for resuming a suspended session, numerous other configurations may also be used to implement embodiments of the present invention.

In at least some embodiments, the system 100 includes a session data source 104 and one or more workstations 102, which may be configured to communicate over the network 106. The network 106 may comprise one or more wireless networks (e.g., a cellular network, wireless local area network, wireless metropolitan area network, and/or the like), one or more wireline networks (e.g., a wired local area network), or some combination thereof, and in some embodiments comprises at least a portion of the internet.

A workstation 102 may be embodied as any computing device configured to enable a user to logon and access session data available from the session data source 104. As non-limiting examples, a workstation 102 may comprise a desktop computer, laptop computer, an access terminal, or the like. In some example embodiments, a workstation 102 may comprise and/or may be operatively coupled to a dedicated piece of machinery or other computing device, which may be used by a user to facilitate performance of an activity in a session. For example, a workstation 102 may comprise a workstation for dispensing medical supplies, a scientific workstation, a laboratory workstation, or the like. In some example embodiments wherein the system 100 comprises multiple workstations 102, each of a plurality of the workstations 102 may have a dedicated function or purpose. For example, respective workstations 102 may be dedicated to dispensing of particular types of pharmaceuticals or other types of medical supplies.

A session data source 104 may be embodied as any computing device or plurality of computing devices configured to store session data and provide the session data to a workstation 102 via the network 106. In this regard, the session data source 104 may be embodied as one or more servers, a server cluster, a cloud computing infrastructure, one or more desktop computers, one or more laptop computers, one or more mobile computers, one or more network nodes, multiple computing devices in communication with each other, any combination thereof, and/or the like. In some example embodiments, the session data storage functionality of the session data source 104 may be at least partially performed by one or more of the workstations 102. In this regard, in some example embodiments, session data storage may be distributed amongst the devices of the system 100. Accordingly, it will be appreciated that session data storage and other functionalities described herein as being performed by the session data source 104 may be performed by one or more other computing devices of the system 100 in other example embodiments.

The system 100 may further comprise one or more user devices 108. A user device 108 may be embodied as any mobile computing device, such as may be carried on a user's person. In this regard, a user device 108 may be embodied as any computing device configured to transmit an identifier to a workstation 102 via a proximity-based communications technology in accordance with one or more example embodiments. As non-limiting examples, a user device 108 may be embodied as a mobile terminal, mobile computer, mobile phone, mobile communication device, tablet computing device, mobile audio/video player, a key fob, or the like.

As mentioned, a user device 108 may be configured to communicate with a workstation 102 via a proximity-based communications technology. A proximity-based communications technology may comprise any wireless communications technology by which two or more computing devices may communicate when they are within a proximate range of each other (e.g., within a communications or signaling range of the proximity-based communications technology). By way of non-limiting example, such proximity-based communications technology may comprise Bluetooth, a communications technique implementing any version of the Institute of Electrical and Electronics Engineers (IEEE) 802.15 standard, ZigBee, Ultra-Wideband, a near field communications technology, infrared, a wireless local area network (WLAN) communications technology, any wireless personal area networking (PAN) technology, or the like. Accordingly, a user device 108 and workstation 102 may communicate via a proximity-based communications link 110 when within sufficient range of each other. A proximity-based communications link 110 may comprise any data link by which data may be communicated via a proximity-based communications technology including, for example, a structured data link that may be established (e.g., a Bluetooth pairing) between a user device 108 and workstation 102, an ad hoc data link, a transient link that may exist only during a signaling duration of a message signaled between a user device 108 and workstation 102, or the like.

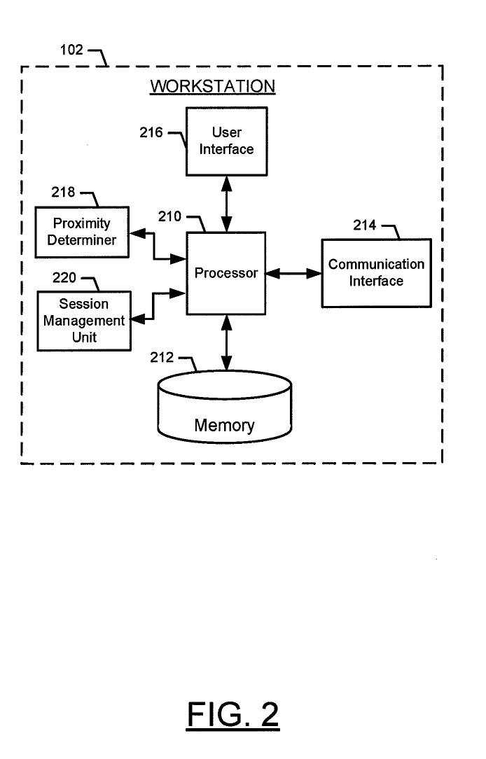

Referring now to FIG. 2, FIG. 2 illustrates a block diagram of a workstation 102 for resuming a suspended session according to an example embodiment. In an example embodiment the workstation 102 includes various means for performing the various functions described herein. These means may include, for example, one or more of a processor 210, memory 212, communication interface 214, user interface 216, proximity determiner 218, or session management unit 220 for performing the various functions herein described. The means of the workstation 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 212) that is executable by a suitably configured processing device (e.g., the processor 210), or some combination thereof.

The processor 210 may, for example, be embodied as various means including one or more microprocessors, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 210 may comprise a plurality of processors. The plurality of processors may be embodied on a single computing device or may be distributed across a plurality of computing devices collectively configured to function as the workstation 102. The plurality of processors may be in operative communication with each other and may be collectively configured to perform one or more functionalities of the workstation 102 as described herein. In an example embodiment, the processor 210 is configured to execute instructions stored in the memory 212 or otherwise accessible to the processor 210. These instructions, when executed by the processor 210, may cause the workstation 102 to perform one or more of the functionalities of the workstation 102 as described herein. As such, whether configured by hardware or software methods, or by a combination thereof, the processor 210 may comprise an entity capable of performing operations according to embodiments of the present invention while configured accordingly. Thus, for example, when the processor 210 is embodied as an ASIC, FPGA or the like, the processor 210 may comprise specifically configured hardware for conducting one or more operations described herein. Alternatively, as another example, when the processor 210 is embodied as an executor of instructions, such as may be stored in the memory 212, the instructions may specifically configure the processor 210 to perform one or more algorithms and operations described herein.

The memory 212 may include, for example, volatile and/or non-volatile memory. Although illustrated in FIG. 2 as a single memory, the memory 212 may comprise a plurality of memories. The plurality of memories may be embodied on a single computing device or distributed across a plurality of computing devices. The memory 212 may comprise, for example, a hard disk, random access memory, cache memory, flash memory, an optical disc (e.g., a compact disc read only memory (CD-ROM), digital versatile disc read only memory (DVD-ROM), or the like), circuitry configured to store information, or some combination thereof In this regard, the memory 212 may comprise any non-transitory computer readable storage medium. The memory 212 may be configured to store information, data, applications, instructions, or the like for enabling the workstation 102 to carry out various functions in accordance with example embodiments of the present invention. For example, in some example embodiments, the memory 212 is configured to buffer input data for processing by the processor 210. Additionally or alternatively, in some example embodiments, the memory 212 is configured to store program instructions for execution by the processor 210. The memory 212 may store information in the form of static and/or dynamic information. This stored information may be stored and/or used by the proximity determiner 218 and/or session management unit 220 during the course of performing their functionalities.

The communication interface 214 may be embodied as any device or means embodied in circuitry, hardware, a computer program product comprising computer readable program instructions stored on a computer readable medium (e.g., the memory 212) and executed by a processing device (e.g., the processor 210), or a combination thereof that is configured to receive and/or transmit data from/to another device, such as, for example, another workstation 102, a session data source 104, a user device 108, and/or the like. In some example embodiments, the communication interface 214 is at least partially embodied as or otherwise controlled by the processor 210. In this regard, the communication interface 214 may be in communication with the processor 210, such as via a bus. The communication interface 214 may include, for example, an antenna, a transmitter, a receiver, a transceiver and/or supporting hardware or software for enabling communications with another computing device. The communication interface 214 may be configured to receive and/or transmit data using any protocol that may be used for communications between computing devices. As an example, the communication interface 214 may be configured to receive and/or transmit data using any protocol and/or communications technology that may be used for communicating over the network 106. As another example, the communication interface 214 may be configured to receive and/or transmit data using any protocol and/or communications technology that may be used for communicating over a proximity-based communications link 110. The communication interface 214 may additionally be in communication with the memory 212, user interface 216, proximity determiner 218, and/or session management unit 220, such as via a bus.

The user interface 216 may be in communication with the processor 210 to receive an indication of a user input and/or to provide an audible, visual, mechanical, or other output to a user. As such, the user interface 216 may include, for example, a keyboard, a mouse, a joystick, a display, a touch screen display, a microphone, a speaker, and/or other input/output mechanisms. The user interface 216 may be in communication with the memory 212, communication interface 214, proximity determiner 218, and/or session management unit 220, such as via a bus.

The proximity determiner 218 may be embodied as various means, such as circuitry, hardware, a computer program product comprising computer readable program instructions stored on a computer readable medium (e.g., the memory 212) and executed by a processing device (e.g., the processor 210), or some combination thereof and, in some example embodiments, is embodied as or otherwise controlled by the processor 210. In embodiments wherein the proximity determiner 218 is embodied separately from the processor 210, the proximity determiner 218 may be in communication with the processor 210. The proximity determiner 218 may further be in communication with one or more of the memory 212, communication interface 214, user interface 216, or session management unit 220, such as via a bus.

The session management unit 220 may be embodied as various means, such as circuitry, hardware, a computer program product comprising computer readable program instructions stored on a computer readable medium (e.g., the memory 212) and executed by a processing device (e.g., the processor 210), or some combination thereof and, in some example embodiments, is embodied as or otherwise controlled by the processor 210. In embodiments wherein the session management unit 220 is embodied separately from the processor 210, the session management unit 220 may be in communication with the processor 210. The session management unit 220 may further be in communication with one or more of the memory 212, communication interface 214, user interface 216, or proximity determiner 218, such as via a bus.

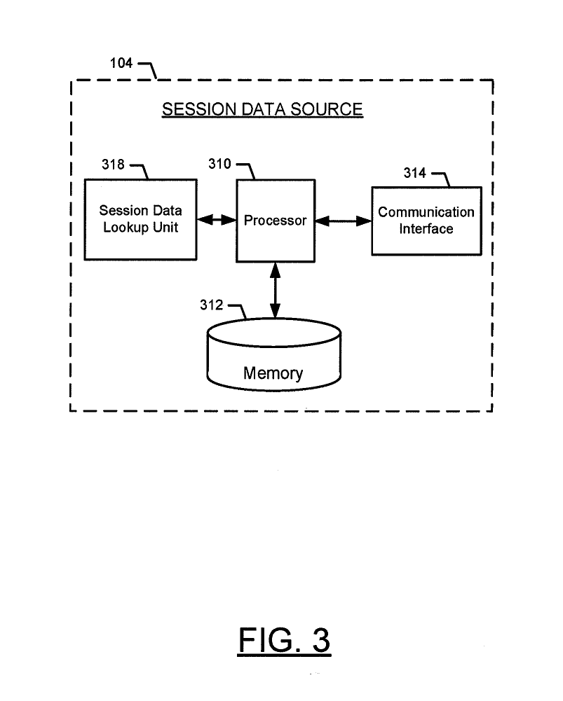

Referring now to FIG. 3, FIG. 3 illustrates a block diagram of a session data source 104 for resuming a suspended session according to an example embodiment. In an example embodiment the session data source 104 includes various means for performing the various functions described herein. These means may include, for example, one or more of a processor 310, memory 312, communication interface 314, or session data lookup unit 318 for performing the various functions herein described. The means of the session data source 104 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 312) that is executable by a suitably configured processing device (e.g., the processor 310), or some combination thereof.

The processor 310 may, for example, be embodied as various means including one or more microprocessors, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments the processor 310 may comprise a plurality of processors. The plurality of processors may be embodied on a single computing device or may be distributed across a plurality of computing devices collectively configured to function as the session data source 104. The plurality of processors may be in operative communication with each other and may be collectively configured to perform one or more functionalities of the session data source 104 as described herein. In an example embodiment, the processor 310 is configured to execute instructions stored in the memory 312 or otherwise accessible to the processor 310. These instructions, when executed by the processor 310, may cause the session data source 104 to perform one or more of the functionalities of the session data source 104 as described herein. As such, whether configured by hardware or software methods, or by a combination thereof, the processor 310 may comprise an entity capable of performing operations according to embodiments of the present invention while configured accordingly. Thus, for example, when the processor 310 is embodied as an ASIC, FPGA or the like, the processor 310 may comprise specifically configured hardware for conducting one or more operations described herein. Alternatively, as another example, when the processor 310 is embodied as an executor of instructions, such as may be stored in the memory 312, the instructions may specifically configure the processor 310 to perform one or more algorithms and operations described herein.

The memory 312 may include, for example, volatile and/or non-volatile memory. Although illustrated in FIG. 3 as a single memory, the memory 312 may comprise a plurality of memories. The plurality of memories may be embodied on a single computing device or distributed across a plurality of computing devices. The memory 312 may comprise, for example, a hard disk, random access memory, cache memory, flash memory, an optical disc (e.g., a compact disc read only memory (CD-ROM), digital versatile disc read only memory (DVD-ROM), or the like), circuitry configured to store information, or some combination thereof. In this regard, the memory 312 may comprise any non-transitory computer readable storage medium. The memory 312 may be configured to store information, data, applications, instructions, or the like for enabling the session data source 104 to carry out various functions in accordance with example embodiments of the present invention. For example, in some example embodiments, the memory 312 is configured to buffer input data for processing by the processor 310. Additionally or alternatively, in some example embodiments, the memory 312 is configured to store program instructions for execution by the processor 310. The memory 312 may store information in the form of static and/or dynamic information. This stored information may be stored and/or used by the session data lookup unit 318 during the course of performing its functionalities.

The communication interface 314 may be embodied as any device or means embodied in circuitry, hardware, a computer program product comprising computer readable program instructions stored on a computer readable medium (e.g., the memory 312) and executed by a processing device (e.g., the processor 310), or a combination thereof that is configured to receive and/or transmit data from/to another device, such as, for example, a workstation 102. In some example embodiments, the communication interface 314 is at least partially embodied as or otherwise controlled by the processor 310. In this regard, the communication interface 314 may be in communication with the processor 310, such as via a bus. The communication interface 314 may include, for example, an antenna, a transmitter, a receiver, a transceiver and/or supporting hardware or software for enabling communications with another computing device. The communication interface 314 may be configured to receive and/or transmit data using any protocol that may be used for communications between computing devices. As an example, the communication interface 314 may be configured to receive and/or transmit data using any protocol and/or communications technology that may be used for communicating over the network 106. The communication interface 314 may additionally be in communication with the memory 312, and/or session data lookup unit 318, such as via a bus.

The session data lookup unit 318 may be embodied as various means, such as circuitry, hardware, a computer program product comprising computer readable program instructions stored on a computer readable medium (e.g., the memory 312) and executed by a processing device (e.g., the processor 310), or some combination thereof and, in some example embodiments, is embodied as or otherwise controlled by the processor 310. In embodiments wherein the session data lookup unit 318 is embodied separately from the processor 310, the session data lookup unit 318 may be in communication with the processor 310. The session data lookup unit 318 may further be in communication with one or more of the memory 312 or communication interface 314, such as via a bus.

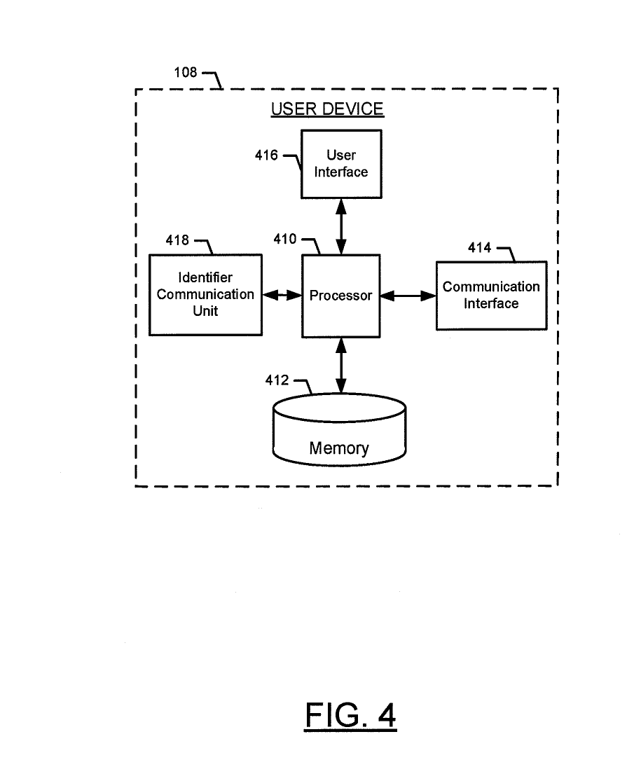

Referring now to FIG. 4, FIG. 4 illustrates a block diagram of a user device 108 for resuming a suspended session according to an example embodiment. In an example embodiment the user device 108 includes various means for performing the various functions described herein. These means may include, for example, one or more of a processor 410, memory 412, communication interface 414, user interface 416, or identifier communication unit 418 for performing the various functions herein described. The means of the user device 108 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 412) that is executable by a suitably configured processing device (e.g., the processor 410), or some combination thereof.

The processor 410 may, for example, be embodied as various means including one or more microprocessors, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 4 as a single processor, in some embodiments the processor 410 may comprise a plurality of processors. The plurality of processors may be in operative communication with each other and may be collectively configured to perform one or more functionalities of the user device 108 as described herein. In an example embodiment, the processor 410 is configured to execute instructions stored in the memory 412 or otherwise accessible to the processor 410. These instructions, when executed by the processor 410, may cause the user device 108 to perform one or more of the functionalities of the user device 108 as described herein. As such, whether configured by hardware or software methods, or by a combination thereof, the processor 410 may comprise an entity capable of performing operations according to embodiments of the present invention while configured accordingly. Thus, for example, when the processor 410 is embodied as an ASIC, FPGA or the like, the processor 410 may comprise specifically configured hardware for conducting one or more operations described herein. Alternatively, as another example, when the processor 410 is embodied as an executor of instructions, such as may be stored in the memory 412, the instructions may specifically configure the processor 410 to perform one or more algorithms and operations described herein.

The memory 412 may include, for example, volatile and/or non-volatile memory. Although illustrated in FIG. 4 as a single memory, the memory 412 may comprise a plurality of memories. The memory 412 may comprise, for example, a hard disk, random access memory, cache memory, flash memory, an optical disc (e.g., a compact disc read only memory (CD-ROM), digital versatile disc read only memory (DVD-ROM), or the like), circuitry configured to store information, or some combination thereof. In this regard, the memory 412 may comprise any non-transitory computer readable storage medium. The memory 412 may be configured to store information, data, applications, instructions, or the like for enabling the user device 108 to carry out various functions in accordance with example embodiments of the present invention. For example, in some example embodiments, the memory 412 is configured to buffer input data for processing by the processor 410. Additionally or alternatively, in some example embodiments, the memory 412 is configured to store program instructions for execution by the processor 410. The memory 412 may store information in the form of static and/or dynamic information. This stored information may be stored and/or used by the identifier communication unit 418 during the course of performing its functionalities.

The communication interface 414 may be embodied as any device or means embodied in circuitry, hardware, a computer program product comprising computer readable program instructions stored on a computer readable medium (e.g., the memory 412) and executed by a processing device (e.g., the processor 410), or a combination thereof that is configured to receive and/or transmit data from/to another device, such as, for example, a workstation 102. In some example embodiments, the communication interface 414 is at least partially embodied as or otherwise controlled by the processor 410. In this regard, the communication interface 414 may be in communication with the processor 410, such as via a bus. The communication interface 414 may include, for example, an antenna, a transmitter, a receiver, a transceiver and/or supporting hardware or software for enabling communications with another computing device. The communication interface 414 may be configured to receive and/or transmit data using any protocol that may be used for communications between computing devices. As an example, the communication interface 414 may be configured to receive and/or transmit data, such as an identifier, to a workstation 102 using via a proximity-based communications link 110. The communication interface 414 may additionally be in communication with the memory 412, user interface 416, and/or identifier communication unit 418, such as via a bus.

The user interface 416 may be in communication with the processor 410 to receive an indication of a user input and/or to provide an audible, visual, mechanical, or other output to a user. As such, the user interface 416 may include, for example, a keyboard, a mouse, a joystick, a display, a touch screen display, a microphone, a speaker, and/or other input/output mechanisms. The user interface 416 may be in communication with the memory 412, communication interface 414, and/or identifier communication unit 418, such as via a bus.

The identifier communication unit 418 may be embodied as various means, such as circuitry, hardware, a computer program product comprising computer readable program instructions stored on a computer readable medium (e.g., the memory 412) and executed by a processing device (e.g., the processor 410), or some combination thereof and, in some example embodiments, is embodied as or otherwise controlled by the processor 410. In embodiments wherein the identifier communication unit 418 is embodied separately from the processor 410, the identifier communication unit 418 may be in communication with the processor 410. The identifier communication unit 418 may further be in communication with one or more of the memory 412, communication interface 414, or user interface 416, such as via a bus.

In some example embodiments, the proximity determiner 218 associated with a workstation 102 may be configured to determine a presence of a user within a predefined proximity of a workstation 102. In this regard, the proximity determiner 218 may, for example, be configured to determine a presence of a user device 108 associated with the user within a predefined proximity of the workstation 102. The predefined proximity may comprise an actual predefined distance range (e.g., within 10 feet) or may comprise a proximity within which two devices may communicate using a particular proximity-based communications technology (e.g., within a range of Bluetooth communication). Accordingly, the proximity determiner 218 may, for example, be configured to determine a presence of a user by determining establishment of a proximity-based communications link 110 (e.g., establishment of a Bluetooth pairing) between a user device 108 and workstation 102, receipt of a proximity-based communication from a user device 108, or the like. In some example embodiments wherein the predefined proximity comprises a predefined distance range, the proximity determiner 218 may be configured to determine a proximity of a user device 108 based at least in part on a signal strength of a proximity-based communication signal received from the user device 108.

In some embodiments, the identifier communication unit 418 associated with a user device 108 may be configured to cause the user device 108 to transmit an identifier to the workstation 102 so as to enable identification of the user associated with the user device 108. By way of non-limiting example, such an identifier may comprise a unique identifier (e.g., alphabetic identifier, numeric identifier, alphanumeric identifier, or the like) assigned to the particular user and/or user device 108, a rolling code that may be synchronized with and interpretable by the workstation 102, some other data that may uniquely identify the user device 108 and/or user thereof, and/or the like. In some embodiments, the identifier communication unit 418 may, for example, be configured to cause transmission of the identifier to the workstation 102 automatically, such as in response to determining that the workstation 102 is within a range of a proximity-based communication technology used by the user device 108, in response to establishment of a proximity-based communication link 110 (e.g., in response to establishment of a Bluetooth pairing) with the workstation 102, or the like. In such embodiments, the proximity determiner 218 may be configured to determine proximity of the user device 108 in response to receipt of an identifier transmitted by the user device 108. In other example embodiments, the identifier communication unit 418 may cause transmission of the identifier in response to a request received from the workstation 102. In this regard, the proximity determiner 218 may, in some embodiments, determine presence of the user device 108 and send an interrogation or other request to the user device 108 requesting transmission of the identifier.

The session management unit 220 associated with the workstation 102 may be configured to cause pre-retrieval of stored session state information for a user in response to a determination of the user's presence within proximity of the workstation 102. In this regard, the session management unit 220 may request session state information for the user from the session data source 104 before the user has physically logged onto the workstation 102, such as by entering credential information (e.g., a username and/or password). The session state information may comprise details of activities previously performed by the user on one or more workstations 102 and may, for example, comprise information on a suspended session of the user. In this regard, a suspended session may comprise a session which the user has previously initiated on the same or another workstation 102 and which was subsequently suspended without completion, such as by the user logging off of a workstation 102.

In some example embodiments, the session management unit 220 may have direct access to session data stored by the session data source and may directly access and retrieve the data, such as over the network 106. Alternatively, the session management unit 220 may cause pre-retrieval of stored session state information by sending a request to the session data source 104. The request may comprise user identification sufficient to enable the session data lookup unit 318 associated with the session data source 104 to lookup and retrieve session state information for the user and respond to the request. In this regard, the request may comprise the identifier received from the user device 108 and/or some user identification data that may be derived there from.

If the user has a suspended session, the pre-retrieved session state information may be sufficient to enable restoration and resumption of the suspended session. If, however, the user does not have a suspended session, such as if the last session of the user was completed rather than suspended, the pre-retrieved session state information may comprise information on one or more most recently performed activities, one or more favorite (e.g., most frequently performed) activities, and/or the like.

The user may subsequently log onto the workstation 102, such as by providing credential information to the workstation 102. It will be appreciated that the credential information may vary depending on the type of logon and/or other security procedures implemented on the particular workstation 102. By way of non-limiting example, provision of the credential information may comprise entry of a username and/or password, swiping a card, providing a biometric input (e.g., fingerprint authentication), presenting a fob or other device with a radio frequency identification (RFID) chip within range of an RFID reader that may be embodied on the workstation 102, or the like. The session management unit 220 may receive the credential information and verify logon of the user.

If the user logon is verified, the session management unit 220 may use the pre-retrieved session state information to resume and/or initiate a session for the user. In this regard, the session management unit 220 may have used the pre-retrieved session state information to prepare in advance for the user logging onto the workstation. Accordingly, the user's wait time may be reduced when the user does log onto the workstation 102. As an example, if the user had a suspended session, the session management unit 220 may use the pre-retrieved session state information to resume the suspended session. In this regard, the user may be presented with the suspended session upon logging onto the workstation 102 such that the user may resume the session where he previously left off. As another example, if the user's previous session was completed rather than suspended, the session management unit 220 may use the pre-retrieved session state information to present the user with a last completed activity(ies), a favorite activity option, and/or the like upon logon. The user may be further presented with options to start a new activity, opt out of the resumed session, begin a new session, and/or the like.

After logging onto the workstation 102, the user may be able to engage in one or more activities attendant to a resumed or new session. The session management unit 220 may be configured to track activities performed while the user is logged onto the workstation 102. The user may subsequently suspend or terminate the session. For example, the user may walk outside of a predefined proximity of the workstation 102. The proximity determiner 218 may determine the departure of the user from proximity of the workstation 102 and the session management unit 220 may automatically suspend or terminate the user's session responsive to the user's departure. As another example, the user may explicitly terminate or suspend his session by logging off of the workstation 102. In response to termination or suspension of a user session on the workstation 102, the session management unit 220 may cause session state information for the user to be updated to reflect the tracked activities. In this regard, the session management unit 220 may directly update session state information for the user stored by the session data source 104 or may send session data detailing the tracked activities to the session data source 104 to enable the session data lookup unit 318 to update the session state information. Accordingly, should the user subsequently resume the session on the same or another workstation 102, session state information reflecting the user's previous activities may be available to enable resumption of the session.

In some example embodiments, a workstation 102 may comprise a shared workstation that may be accessed by multiple users. Accordingly, one or more users may be within a proximity of the workstation 102 waiting to use the workstation 102 while another user is logged onto the workstation 102. In some example embodiments, the session manager 220 may be configured to cause display of a visual indication (e.g., an icon, the user's name, or other visual indication) of a user determined to be within a proximity of the workstation 102 to be displayed on a display of the workstation 102. This visual indication may be selectable to enable the user to provide the user's credential information for logging onto the workstation 102. Accordingly, if a user selects the visual indication of his name, the session manager 102 may access the correct pre-retrieved session state information for that particular user to enable resumption of a suspended user session upon the user logging onto the workstation 102. Display of a visual indication(s) of waiting user(s) may also alert another user using the workstation 102 that there are other user(s) waiting to use the workstation 102. Accordingly, the user using the workstation 102 may know that the user should not monopolize usage of the workstation 102.

In some example embodiments, if multiple users are within proximity of the workstation 102, the session manager 220 may be configured to determine an ordering of the users. This ordering may, for example, be based at least in part on an order in which the presence of the users were detected. In some example embodiments, however, one or more user's sessions may have an associated priority. In such embodiments, the session manager 220 may determine an ordering of the users further based on priority. For example, if a second user is not first in time, but has a suspended session having a higher priority than a session of a first user who first came within proximity of the workstation 102, the session manager 220 may order the second user before the first user. The visual indications of the waiting users may be displayed in the determined order. Accordingly, waiting users may be made aware of an order in which they should log onto the workstation 102. In some embodiments, this ordering may be a suggested ordering and users may log on out of turn. In other embodiments, however, the determined ordering may be enforced by the session manager 220 such that only a next-in-line user may log on.

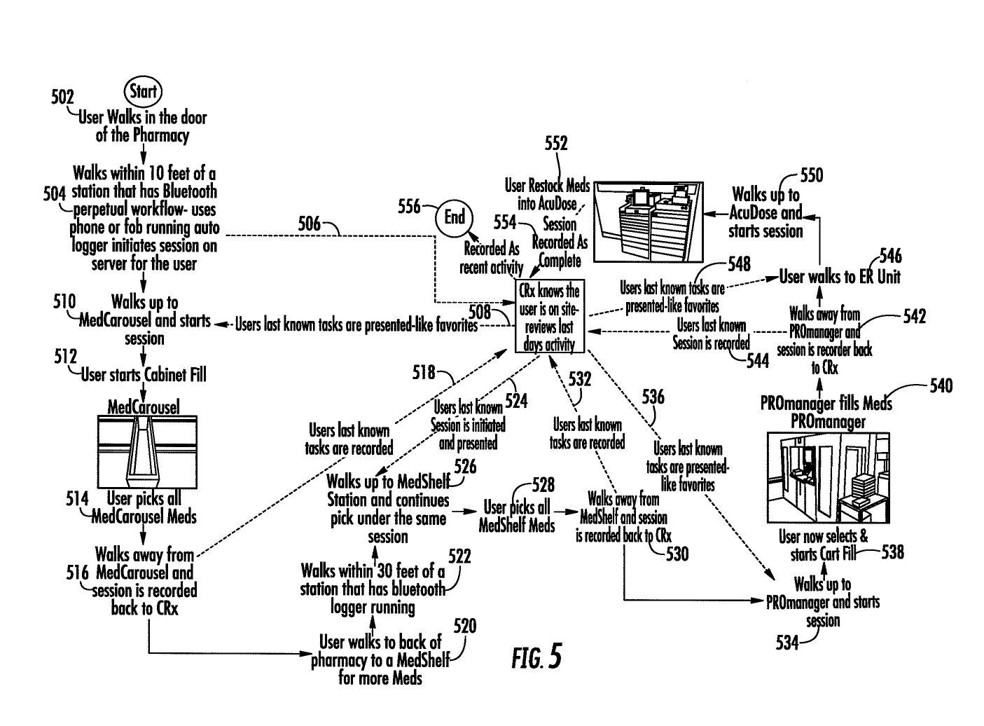

Having now generally described several example embodiments, a more detailed example workflow will now be described in an example embodiment wherein the system 100 is implemented in the context of a hospital pharmacy. In this regard, FIG. 5 illustrates an example multi-station workflow according to an example embodiment wherein a plurality of workstations 102 may dispense medical supplies. In particular, FIG. 5 illustrates application of an embodiment of the invention to McKesson's CRx™ pharmacy system. Referring now to FIG. 5, operation 502 may comprise a user walking into a pharmacy. The user may have a user device 108 on his or her person. At operation 504, the user may walk within a predefined proximity (e.g., 10 feet) of a workstation, such as a MedCarousel® workstation. The workstation may determine the presence of the user's device 108 and may automatically cause pre-retrieval of session state information for the user to enable initiation of a user session, at operation 506. The CRx™ server (e.g., an embodiment of the session data source 104) may review the user's recent activity and determine that the user does not have a suspended session. The CRx™ server may accordingly provide the user's last known tasks and/or favorite tasks to the workstation, at operation 508. Operation 510 may comprise the user logging onto the workstation to start a session. The data provided to the user upon logging onto the workstation may be determined based at least in part on the session data provided to the workstation in operation 508. Operations 512 and 514 may comprise the user obtaining pharmaceutical supplies from the MedCarousel® station. At operation 516, the user may walk away from the MedCarousel® station, which may detect that the user is no longer within proximity of the workstation. Accordingly, operation 518 may comprise suspending the user's session in response to the user walking away from the workstation and recording the user's tasks performed on the workstation to the CRx™ server to update the session state information maintained by the server.

Operations 520 and 522 may comprise the user walking within a predefined proximity (e.g., 30 feet) of a second workstation, such as a MedShelf™ workstation. The MedShelf™ workstation may determine the presence of the user and may pre-retrieve the session state information for the user's suspended session from the CRx™ server, at operation 524. Operation 526 may comprise the user logging onto the MedShelf™ workstation. The suspended session may be resumed on the basis of the pre-retrieved session state information. The user may obtain pharmaceutical supplies from the MedShelf™ workstation, at operation 528. The user may then walk away from the MedShelf™ workstation, which may, at operation 530, detect that the user is no longer within proximity of the workstation. Accordingly, operation 532 may comprise suspending (or terminating, if the session is complete) the user's session in response to the user walking away from the workstation and recording the user's tasks performed on the workstation to the CRx™ server to update the session state information maintained by the server.

Operation 534 may comprise the user walking within a predefined proximity (of a third workstation, such as a PROmanager™ workstation. The PROmanager™ workstation may determine the presence of the user and may pre-retrieve session state information for the user from the CRx™ server, at operation 536. The user may then log onto the PROmanager™ workstation. If the user's session had been previously suspended, the suspended session may be resumed on the basis of the pre-retrieved session state information. Alternatively, if the user's session had been completed or otherwise terminated, the user may be presented with the user's last known tasks and/or favorite tasks. Operation 538 may comprise the user selecting and starting a Cart Fill activity, and the PROmanager™ workstation may fill one or more medications, at operation 540. The user may then walk away from the PROmanager™ workstation, which may, at operation 542, detect that the user is no longer within proximity of the workstation. Accordingly, operations 542 and 544 may comprise suspending (or terminating, if the session is complete) the user's session in response to the user walking away from the workstation and recording the user's tasks performed on the workstation to the CRx™ server to update the session state information maintained by the server.

The user may walk into an emergency room (ER) unit within a predefined proximity of a fourth workstation, such as an AcuDose-RX® workstation, at operation 546. The AcuDose-RX® workstation may determine the presence of the user and may pre-retrieve session state information for the user from the CRx™ server, at operation 548. The user may then log onto the AcuDose-RX® workstation, at operation 550. If the user's session had been previously suspended, the suspended session may be resumed on the basis of the pre-retrieved session state information. Alternatively, if the user's session had been completed or otherwise terminated, the user may be presented with the user's last known tasks and/or favorite tasks. Operation 552 may comprise the user restocking medicines (e.g., medicines that may have been collected in operations 514, 528, and 540) into the AcuDose-RX® workstation. The user may then complete restocking the AcuDose-RX® workstation and terminate the session, such as by logging out or by walking away from the workstation. At operation 554, the user's activities may be recorded to the CRx™ and/or the session may be recorded as completed. The user's most recent session activities may then be available as recent activity for a subsequent session, as noted in operation 556.

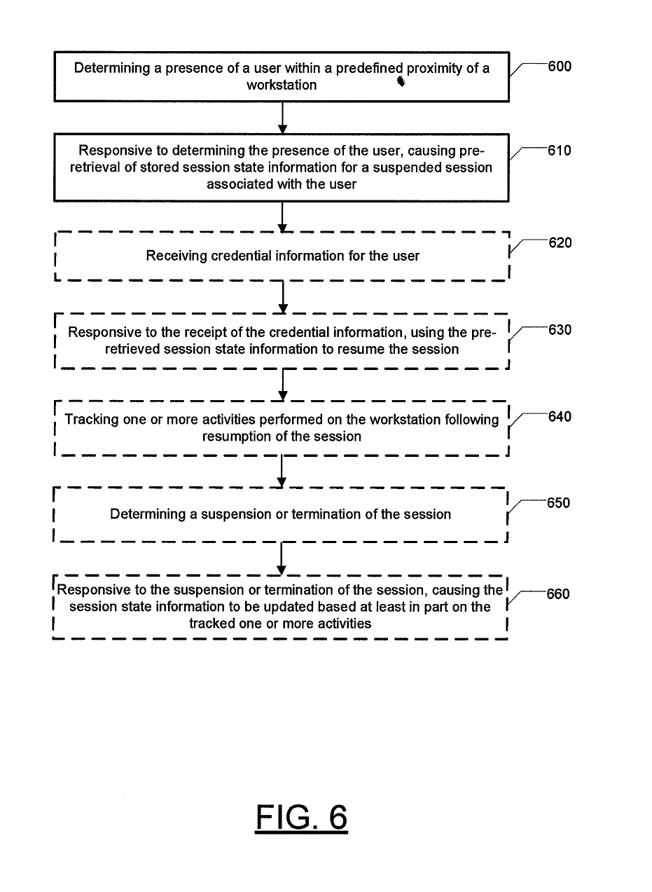

FIG. 6 illustrates a flowchart according to an example method for resuming a suspended session according to an example embodiment. In this regard, FIG. 6 illustrates a method that may be performed at a workstation 102. The operations illustrated in and described with respect to FIG. 6 may, for example, be performed by, with the assistance of, and/or under the control of one or more of the processor 210, memory 212, communication interface 214, user interface 216, proximity determiner 218, or session management unit 220. Operation 600 may comprise determining a presence of a user within a predefined proximity of a workstation. In response to determining the presence of the user, operation 610 may comprise causing pre-retrieval of stored session state information (e.g., from a session data source 104) for a suspended session associated with the user.

The method may optionally further comprise one or more of operations 620-660. Operation 620 may comprise receiving credential information for the user. In response to receipt of the credential information, operation 630 may comprise using the pre-retrieved session state information to resume the session. Operation 640 may comprise tracking one or more activities performed on the workstation following resumption of the session. The method may further include determining a suspension or a termination of the session, at operation 650. In response to the suspension or termination of the session, operation 660 may comprise causing the session state information to be updated based at least in part on the tracked activities.

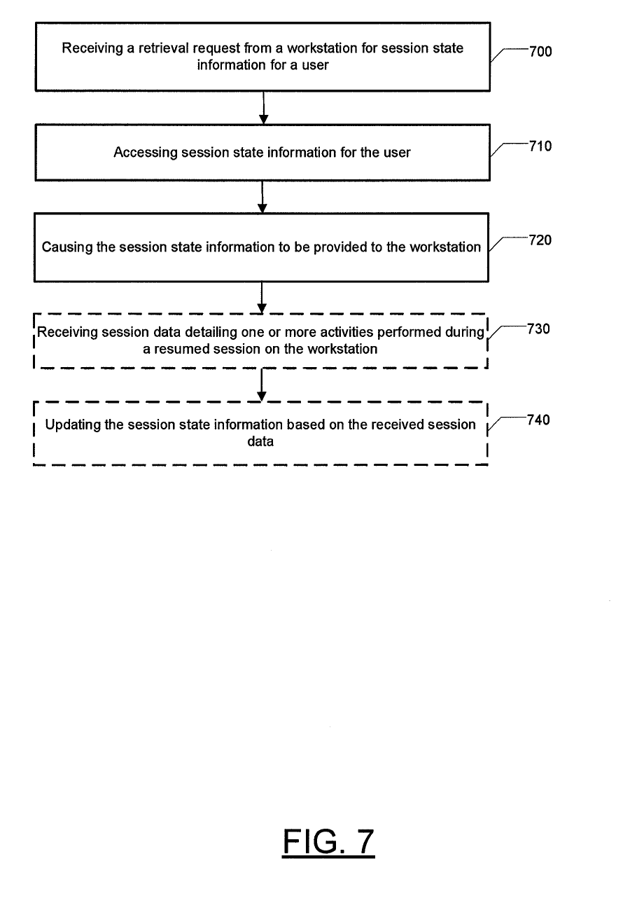

FIG. 7 illustrates a flowchart according to an example method for facilitating retrieval of session state information for a suspended session according to an example embodiment. In this regard, FIG. 7 illustrates operations that may be performed at a session data source 104. The operations illustrated in and described with respect to FIG. 7 may, for example, be performed by, with the assistance of, and/or under the control of one or more of the processor 310, memory 312, communication interface 314, or session data lookup unit 318. Operation 700 may comprise receiving a retrieval request from a workstation for session state information for a user. Operation 710 may comprise accessing the requested session state information. The method may further include causing the requested session state information to be provided to the workstation, at operation 720.

The method may optionally further include one or more of operations 730 and 740. Operation 730 may comprise receiving session data detailing one or more activities performed during a resumed session on the workstation. Operation 740 may comprise updating the session state information based on the received session data.

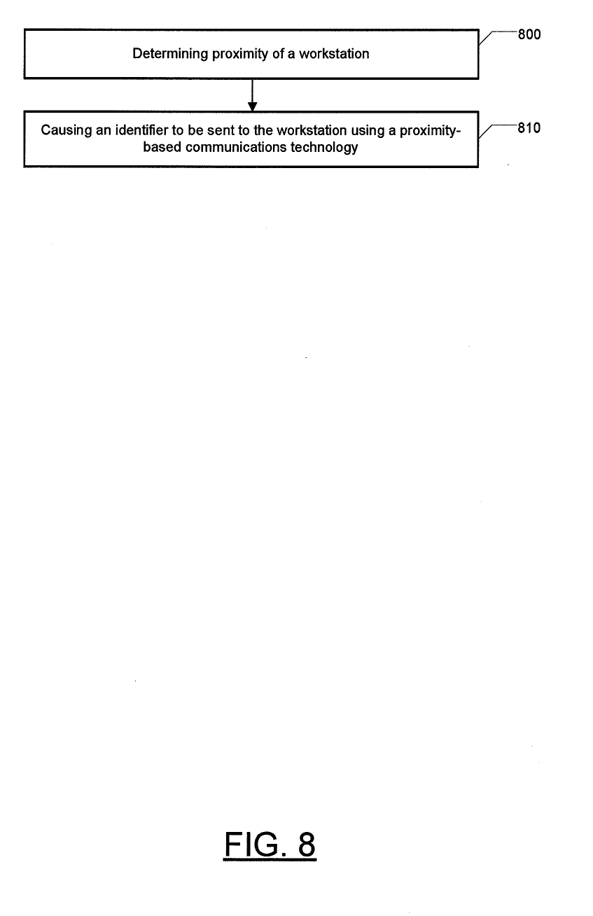

FIG. 8 illustrates a flowchart according to an example method for triggering pre-retrieval of session state information for resuming a suspended session according to an example embodiment. In this regard, FIG. 8 illustrates a method that may be performed at a user device 108. The operations illustrated in and described with respect to FIG. 8 may, for example, be performed by, with the assistance of, and/or under the control of one or more of the processor 410, memory 412, communication interface 414, user interface 416, or identifier communication unit 418. Operation 800 may comprise determining proximity of a workstation. In this regard, operation 800 may comprise determining an establishment of a proximity-based communications link 110 with a workstation, receiving a request for an identifier from the workstation, determining a proximity-based communications technology transmission by the workstation, or the like. Operation 810 may comprise causing an identifier to be sent to the workstation using a proximity-based communications technology.

FIGS. 6-8 each illustrate a flowchart of a system, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a server, desktop computer, laptop computer, mobile computer, or other computing device (e.g., a workstation 102, session data source 104, user device 108, combination thereof, and/or the like) and executed by a processor (e.g., the processor 210, processor 310, and/or processor 410) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowcharts support combinations of means for performing the specified functions and combinations of steps for performing the specified functions. It will also be understood that one or more blocks of the flowcharts, and combinations of blocks in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for resuming a suspended session, the method comprising:
determining a presence of a user within a predefined proximity of a workstation; and
responsive to determining the presence of the user, causing pre-retrieval of stored session state information for a suspended session associated with the user before the user enters credential information for logging onto the workstation.

2. The method of claim 1, wherein determining the presence of the user comprises receiving an identifier transmitted by a mobile computing device associated with the user via a proximity-based communications technology.

3. The method of claim 2, wherein the proximity-based communications technology comprises Bluetooth.

4. The method of claim 1, wherein determining a presence of a user within a predefined proximity of a workstation comprises determining a presence of the user within a predefined proximity of a first workstation, and wherein the session state information comprises information on activities performed on a second workstation prior to suspension of the session, the second workstation being separate from the first workstation.

5. The method of claim 1, further comprising:
receiving credential information for the user; and
responsive to the receipt of the credential information, using the pre-retrieved session state information to resume the session.

6. The method of claim 5, further comprising:
tracking one or more activities performed on the workstation following resumption of the session;
determining one or more of a suspension or a termination of the session; and
responsive to suspension or termination of the session, causing the session state information to be updated based at least in part on the tracked one or more activities.

7. The method of claim 1, further comprising causing a visual indication of the user to be displayed on a display of the workstation in response to determining the presence of the user, the visual indication being selectable to enable entry of the user's credential information for logging onto the workstation and resuming the suspended session.

8. The method of claim 7, wherein the user comprises a first user and the session comprises a first session, the method further comprising:
determining a presence of a second user within the predefined proximity of the workstation;
responsive to determining the presence of the second user, causing pre-retrieval of stored session state information for a second suspended session associated with the second user;
determining a priority associated with at least one of the first session or the second session;
determining an ordering of the first and second sessions based at least in part on the determined priority; and
causing visual indications of the first and second users to be displayed on the display in accordance with the determined ordering.

9. The method of claim 1, wherein the workstation comprises a workstation for dispensing medical supplies, and wherein the session state information comprises medical supply order information.

10. An apparatus for resuming a suspended session, the apparatus comprising at least one processor, wherein the at least one processor is configured to cause the apparatus to at least:
determine a presence of a user within a predefined proximity of a workstation; and
responsive to determining the presence of the user, cause pre-retrieval of stored session state information for a suspended session associated with the user before the user enters credential information for logging onto the workstation.

11. The apparatus of claim 10, wherein the at least one processor is configured to cause the apparatus to determine the presence of the user at least in part by receiving an identifier transmitted by a mobile computing device associated with the user via a proximity-based communications technology.

12. The apparatus of claim 11, wherein the proximity-based communications technology comprises Bluetooth.

13. The apparatus of claim 10, wherein the at least one processor is configured to cause the apparatus to determine a presence of a user within a predefined proximity of a workstation by determining a presence of the user within a predefined proximity of a first workstation, and wherein the session state information comprises information on activities performed on a second workstation prior to suspension of the session, the second workstation being separate from the first workstation.

14. The apparatus of claim 10, wherein the at least one processor is configured to further cause the apparatus to:
receive credential information for the user; and
responsive to the receipt of the credential information, use the pre-retrieved session state information to resume the session.

15. The apparatus of claim 14, wherein the at least one processor is configured to further cause the apparatus to:
track one or more activities performed on the workstation following resumption of the session;
determine one or more of a suspension or a termination of the session; and
responsive to suspension or termination of the session, cause the session state information to be updated based at least in part on the tracked one or more activities.

16. The apparatus of claim 10, wherein the at least one processor is configured to further cause the apparatus to:
cause a visual indication of the user to be displayed on a display of the workstation in response to determining the presence of the user, the visual indication being selectable to enable entry of the user's credential information for logging onto the workstation and resuming the suspended session.

17. The apparatus of claim 16, wherein the at least one processor is configured to further cause the apparatus to:
determine a presence of a second user within the predefined proximity of the workstation;
responsive to determining the presence of the second user, cause pre-retrieval of stored session state information for a second suspended session associated with the second user;
determine a priority associated with at least one of the first session or the second session;
determine an ordering of the first and second sessions based at least in part on the determined priority; and
cause visual indications of the first and second users to be displayed on the display in accordance with the determined ordering.

18. The apparatus of claim 10, wherein the workstation comprises a workstation for dispensing medical supplies, and wherein the session state information comprises medical supply order information.

19. The apparatus of claim 10, further comprising at least one memory storing instructions that when executed by the at least one processor cause the apparatus to:
determine a presence of a user within a predefined proximity of a workstation; and
responsive to determining the presence of the user, cause pre-retrieval of stored session state information for a suspended session associated with the user before the user enters credential information for logging onto the workstation.

20. A computer program product for resuming a suspended session, the computer program product comprising at least one non-transitory computer-readable storage medium having computer-readable program instructions stored therein, the computer-readable program instructions comprising:
program instructions configured to determine a presence of a user within a predefined proximity of a workstation; and
program instructions configured, responsive to determining the presence of the user, to cause pre-retrieval of stored session state information for a suspended session associated with the user before the user enters credential information for logging onto the workstation.
